(19) United States
(12) Patent Application Publication
(10) Pub. No.: US 2025/0178111 A1
(43) Pub. Date: Jun. 5, 2025

(54) BATTERY MANAGEMENT SYSTEM FOR WELDING POWER SOURCE POWERED BY DETACHABLE BATTERY PACKS

(71) Applicant: ESAB AB, Goteborg (SE)

(72) Inventors: Mark Lowther, Warrington (GB); Govarthanan Rengamuni, Chennai (IN); Paramasivam Shanmugam, Chennai (IN); Sankar Selvakumar, Chennai (IN)

(21) Appl. No.: 18/978,047

(22) Filed: Dec. 12, 2024

Related U.S. Application Data
(63) Continuation of application No. PCT/IB2023/056282, filed on Jun. 16, 2023.

(30) Foreign Application Priority Data
Jun. 17, 2022 (IN) 202241034745

(51) Int. Cl. B23K 9/10; H01M 10/42; H01M 10/48

(52) U.S. Cl. CPC B23K 9/1012; H01M 10/425; H01M 10/48; H01M 2220/30

(57) ABSTRACT

A method performed by a welding system configured to be powered by a battery to generate weld power to strike an arc for a welding or a plasma cutting operation includes: receiving a selection of a welding mode among different welding modes in which the welding system is capable of operating, to produce a selected welding mode; determining, for the selected welding mode, an energy consumption requirement that depends on the selected welding mode; determining a state of charge (SOC) of the battery and a battery energy from the SOC; determining a remaining amount of welding or plasma cutting that is supported by the battery energy based on the battery energy and the energy consumption requirement; and presenting an indication of the remaining amount for the selected welding mode.

### CLAIM TO PRIORITY

This application is a continuation of International (PCT) Patent Application No. PCT/IB2023/056282, filed Jun. 16, 2023, and entitled “BATTERY MANAGEMENT SYSTEM FOR WELDING POWER SOURCE POWERED BY DETACHABLE BATTERY PACKS,” which claims priority to and is based on Indian Application No. 202241034745, filed Jun. 17, 2022, and entitled “BATTERY MANAGEMENT SYSTEM FOR WELDING POWER SOURCE POWERED BY DETACHABLE BATTERY PACKS.” The entire disclosure of each of these applications is incorporated herein by reference.

### TECHNICAL FIELD

The subject disclosure relates to battery monitoring and control techniques for a battery used as a welding power source.

### BACKGROUND

A battery-powered power source for a welding system generates welding power (also referred to as “weld power”) for a welding or cutting operation using battery power provided by batteries of a battery system. For example, the battery system may include a plurality of power tool batteries connected in series and housed in a battery box or a caddy, where each individual power tool battery is itself a battery pack of several battery cells within a single battery housing. The battery system requires a battery monitoring system to control and monitor a health of the batteries.

Besides supplying DC power, power tool batteries typically supply control signals that can be used by a connected device to monitor battery conditions. For example, a power tool battery may generate an output signal indicating the total voltage available from the battery cells within its internal battery pack and a separate output signal indicating the voltage of about half of the stack of battery cells in its internal battery pack, i.e., a “split stack” voltage. These signals can be used to determine the state of charge of the battery pack and to detect unwanted voltage imbalances among the individual battery cells of the battery pack within a single power tool battery. A power tool battery may also generate an output signal indicative of the internal temperature of the battery pack. All of these control signals can be in the form of low-power voltages that can be sensed by circuitry of the device to which the battery is connected.

Power tool batteries are generally designed to be used individually, such that the voltages of the supplied control signals are relative to the ground state of the single power tool battery. To meet the relatively high power requirements of welding operations, it may be desirable to connect several power tool batteries in series within the battery system of a welding power source. In this configuration, however, each battery is at a different ground potential relative to the other batteries in series (i.e., the negative terminals of the batteries are at different potentials from each other). Consequently, the control signals from each battery in series are relative to different voltage levels. To enable meaningful interpretation of the control signals of the set of batteries, one option would be to electrically isolate the individual ground levels of the batteries from each other. However, ensuring such individualized grounds disadvantageously adds complexity and cost to the battery monitoring system. Thus, it would be desirable to enable reading and correctly interpreting of the control signals from several power tool batteries connected in series without requiring ground isolation circuitry for the batteries within the battery monitoring system.

A battery-powered power source for welding drains battery power from a battery during a welding process, until the battery can no longer support the welding process. At any given time, information that indicates how much longer the battery can support the welding process is useful to a weld operator, who can plan welding operations accordingly; however, conventional system do not make such information available to the weld operator.

### BRIEF DESCRIPTION OF THE DRAWINGS

FIG. 1 is a high-level block diagram of an example welding or plasma cutting system (generally referred to as a “welding system”) that includes a hybrid-powered (HP) power source configured to derive/generate output weld power for a welding or plasma cutting operation from one or both of AC input power and battery power provided by a battery system.

FIG. 2 is a high-level block diagram of the battery system according to an embodiment.

FIG. 3 is a circuit diagram of example sense circuits for one battery of a set of series-connected batteries in the battery box.

FIG. 4 is an illustration of an example technique of measuring separate sets of sense voltages from individual batteries of the battery pack with reference to a common negative terminal potential.

FIG. 5 is a flowchart of an example method of determining a remaining arc ON time or a remaining number of stick electrodes that can be welded for different types of welding processes based on a state of charge (SOC) of a battery of the battery system.

FIG. 6 is an illustration of an example user interface (UI) that a controller of the battery system may generate for display, and that a human machine interface (HMI) of the welding system may display in connection with methods presented herein.

FIG. 7 is an illustration of an example HMI of the welding system.

FIG. 8 is a flowchart of another example method of determining a remaining amount of welding or plasma cutting activity that is supported by the battery for a selected welding mode.

FIG. 9 is a block diagram of an example controller configured to perform operations described herein.

### DETAILED DESCRIPTION

### Overview

In an embodiment, a method performed by a welding system configured to be powered by a battery to generate weld power to strike an arc for a welding or a plasma cutting operation includes: receiving a selection of a welding mode among different welding modes in which the welding system is capable of operating, to produce a selected welding mode; determining, for the selected welding mode, an energy consumption requirement that depends on the selected welding mode; determining a state of charge (SOC) of the battery and a battery energy from the SOC; determining a remaining amount of welding or plasma cutting that is supported by the battery energy based on the battery energy and the energy consumption requirement; and presenting an indication of the remaining amount for the selected welding mode.

### Example Embodiments

Embodiments presented herein are directed to battery management. The embodiments provide various techniques to monitor battery health of a battery configured to provide battery power to/for a welding process. The battery comprises multiple series-connected batteries. The techniques monitor/determine the battery health of the series-connected batteries individually, as well as their combined battery health. For purposes of monitoring battery health, the techniques measure/sense voltages (i.e., “battery sense voltages”) of individual ones of the series-connected batteries, with reference to a common ground presented by one of the batteries. This advantageously avoids reliance on electrically isolated individual terminals (e.g., ground terminals) for the individual batteries and thereby reduces complexity and cost of the battery and the battery management.

The techniques to monitor the battery health measure the battery sense voltages provided by each of the series-connected batteries, and determine battery health parameters for each of the series-connected batteries based on their measured sense voltages. The battery health parameters include, for each of the series-connected batteries, a type of battery (e.g., an ampere-hour (Ah) rating of the battery), a battery (output) voltage, a battery temperature, and a battery state of charge (SOC). Each of the series-connected batteries itself comprises multiple series-connected battery cells (referred to simply as “cells”). Thus, the techniques also determine whether the series-connected cells comprising each battery are balanced or imbalanced.

Further techniques employ the SOCs for the individual series-connected batteries to determine, at any given time, (i) a remaining arc ON time that can be supported by the batteries in various types of welding processes, such as manual metal arc (MMA) welding, tungsten inert gas (TIG) welding, and gas metal arc welding (GMAW) processes, for example. For the MMA welding process, the techniques further determine a number of stick electrodes that can be welded with the remaining battery power, based on the SOCs for the series-connected batteries. In addition, the techniques present the aforementioned information on a human machine interface (HMI) for consumption by a weld operator.

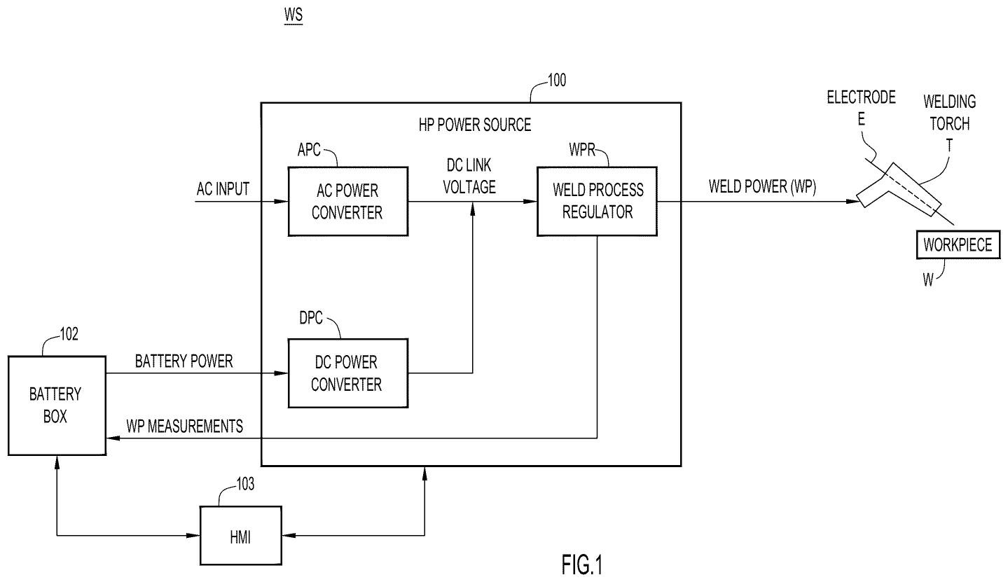

FIG. 1 is a high-level block diagram of an example welding or plasma cutting system WS (generally referred to as a “welding system”) that includes a hybrid-powered (HP) power source 100 configured to derive output weld power (WP) for a welding or plasma cutting operation from one or both of AC input power (e.g., provided through an AC mains connector, not shown) and battery power provided by a battery system (also referred to as a “battery box”) 102. The weld power WP includes weld current (also referred to as “weld output current”) and weld voltage (also referred to as “weld output voltage”). HP power source 100 supplies the output weld power WP through a welding cable (not shown) to a welding torch T (sometimes referred to as a “welding gun”) associated with a consumable electrode E, in order to strike an arc on a workpiece W. While described herein in the context of a hybrid-powered welding power source, it will be appreciated that the described concepts relating to the monitoring of a set of series connected batteries are equally applicable in a welding power source that relies solely on battery power and not AC power.

Battery box 102 and HP power source 100 may each communicate with a human machine interface (HMI) 103, which represents a user interface through which an operator may interact with the battery box and the HP power source. In addition, HP power source includes sense points (not shown) that provide to battery box 102 measurements of the weld power, i.e., a measurement of the weld current (referred to as a “measured weld current”) and a measurement of the weld voltage (referred to a “measured weld voltage”).

HP power source 100 includes an AC power converter APC, a DC power converter DPC, and a weld process regulator WPR. AC power converter APC includes a rectifier and additional circuitry (not shown) to convert the AC input power to a DC link voltage and provides the same to weld process regulator WPR. DC power converter DPC includes a DC-DC converter and additional circuitry (not shown) to convert the battery power to the DC link voltage and provides the same to weld process regulator WPR. Weld process regulator WPR includes a power inverter, a transformer, and rectification circuitry (not shown) to convert the DC link voltage to (regulated) weld power WP for the welding or plasma cutting operation.

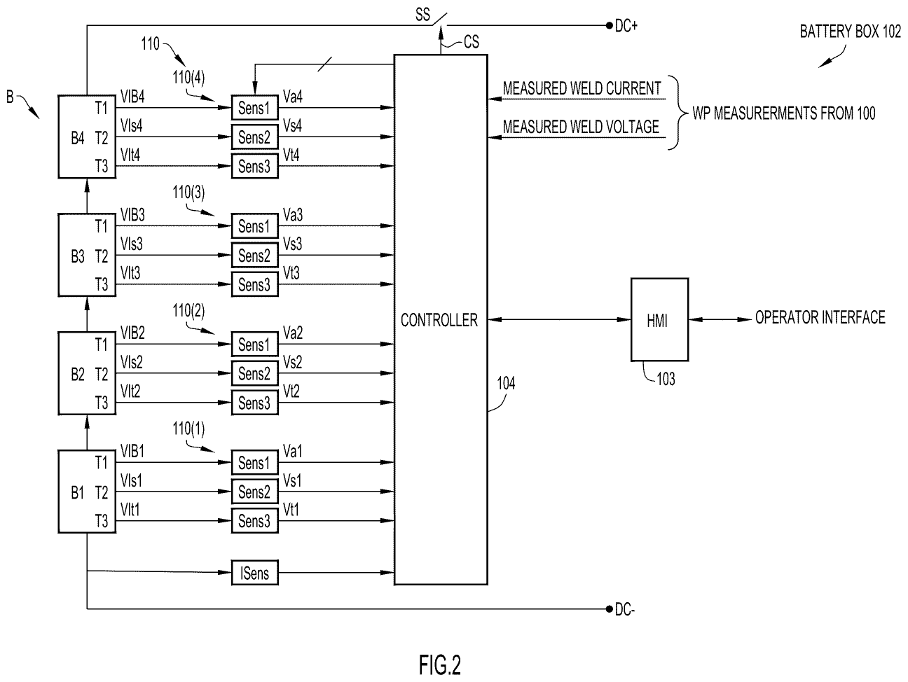

FIG. 2 is a high-level block diagram of battery box 102 coupled with HMI 103 according to an embodiment. Battery box 102 includes a controller 104 to provide overall control of the battery box, positive and negative DC output terminals DC+, DC− to be connected to HP power source 100, and a set of distinct batteries B1, B2, B3, and B4 (collectively referred to as “batteries B”) connected in series with each other (i.e., from one output battery terminal to the next in succession) from negative output terminal DC− to positive output terminal DC+. Controller 104 receives from HP power source 100 the weld power WP measurements, including the measured weld current and the measured weld voltage.

Batteries B1-B4 collectively produce the battery power delivered to HP power source 100 through positive output terminal DC+. Each battery Bi itself includes multiple (e.g., 5) series-connected batteries or “cells” in an individual battery pack that represents the battery Bi. Battery box 102 further includes at least one switch SS (e.g., a relay), connected from an output terminal of battery B4 (e.g., a positive terminal of battery B4) to output terminal DC+, controlled (i.e., opened or closed) by at least one control signal CS generated by controller 104. When controller 104 closes/opens switch SS, batteries B provide/disconnect battery power to/from positive output terminal DC+. While controller 104 is shown as part of battery box 102, it is understood that the functionality of controller may be distributed across the battery box and other sections of a welding system.

Each of batteries B is equipped with multiple (e.g., a set of 3) sense voltage terminals that provide multiple sense voltages indicative of different characteristics of the batteries. Specifically, each battery Bi respectively includes sense terminals T1, T2, T3 that provide a battery voltage VIBi (i.e., an output voltage produced by the battery Bi), a split stack voltage VISi, and a temperature voltage VIti indicative of a temperature of the battery Bi, respectively. More specifically, as shown in FIG. 2:
a. Battery B1 sense terminals [T1, T2, T3] provide sense voltages [VIB1, VIs1, VIt1].
b. Battery B2 sense terminals [T1, T2, T3] provide sense voltages [VIB2, VIs2, VIt2].
c. Battery B3 sense terminals [T1, T2, T3] provide sense voltages [VIB3, VIs3, VIt3].
d. Battery B4 sense terminals [T1, T2, T3] provide sense voltages [VIB4, VIs4, VIt4]

For purposes of monitoring battery health of individual ones of batteries B1-B4, controller 104 measures the sets of 3 sense voltages from each of batteries B1-B4 through respective sets of selectively enabled sense circuits 110(1)-110(4) (collectively referred to as “sense circuits 110,”) and also referred to as “battery voltage conditioning circuits”) connected to/between the batteries and the controller. When enabled by enable signals 112 generated by controller 104, sense circuits 110 convert the sense voltages (e.g., VIB1) to sensed voltages (e.g., Va1), and provide the sensed voltages to controller 104. Controller 104 monitors the sense voltages provided by batteries B1-B4 through the sensed voltages in order to determine an individual battery health of each battery Bi, and an overall/combined battery health for batteries B1-B4, based on the sensed voltages. Each set of sense circuits 110 (i) respectively includes 3 parallel sense circuits (denoted “Sens1”−“Sens3” in FIG. 2) connected from terminals T1-T3 of battery Bi to corresponding ones of 3 sense inputs of controller 104. Sense circuits 110 sense their respective sense voltages (and provide their corresponding sensed voltages) with reference to a common ground for all of batteries B1-B4, as will be described below. More specifically, as shown in FIG. 2:
a. Battery B1 sense circuits 110(1) (e.g., Sens1, Sens2, and Sens3) convert sense voltages [VIB1, VIs1, VIt1] (from battery B1 terminals [T1, T2, T3]) to sensed voltages [Va1, Vs1, Vt1].
b. Battery B2 sense circuits 110(2) covert sense voltages [VIB2, VIs2, VIt2] to sensed voltages [Va2, Vs2, Vt2].
c. Battery B3 sense circuits 110(3) convert sensed voltages sense voltages [VIB3, VIs3, VIt3] to sense voltages [Va3, Vs3, Vt3].
d. Battery B4 sense circuits 110(4) convert sense voltages [VIB4, VIs4, VIt4] to sensed voltages [Va4, Vs4, Vt4].

Battery box 102 also includes a current sensor Isens that senses current provided by batteries B, and provides the sensed current to controller 104. Controller 104 may include an analog-to-digital (ADC) module to convert the sensed voltages and the sensed current to corresponding digitized signals, which are processed by the controller.

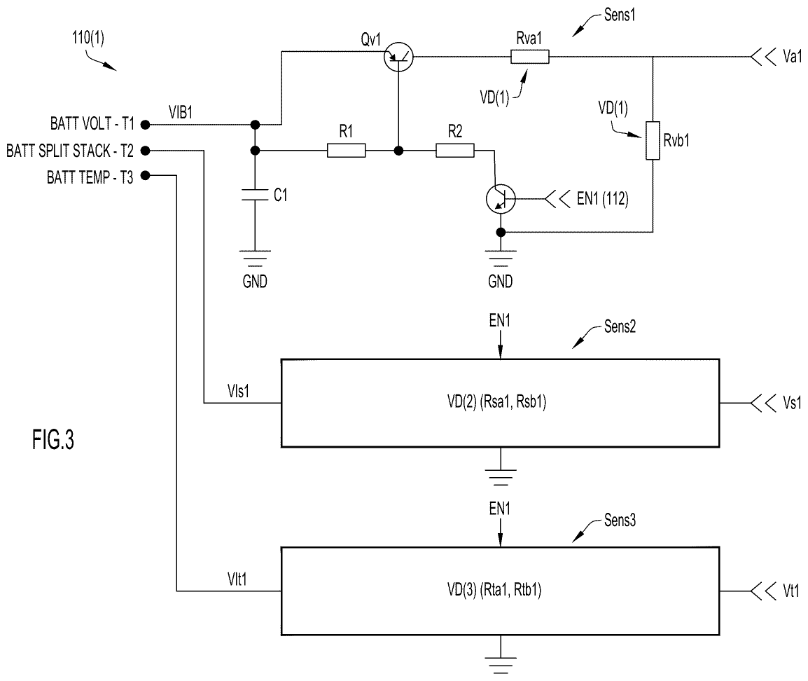

FIG. 3 is a circuit diagram for sense circuits Sens1, Sens2, and Sens3 of the set of sense circuits 110(1) for battery B1, according to an embodiment. The general configuration of FIG. 3 is repeated for each battery. As shown in FIG. 3, sense circuit Sens1 converts battery voltage VIB1 (where “B” denotes “battery voltage” and “1” denotes battery B1) to sensed voltage Va1, sense circuit Sens2 converts battery split stack voltage VIs1 to sensed voltage Vs1, and sense circuit Sens3 converts battery temperature voltage VIt1 to sensed voltage Vt1. The circuits Sens1-Sens3 are individually and independently controlled by controller 104, as described below.

Sense circuit Sens1 includes a PNP transistor Qv1 connected to a voltage divider VD(1) comprising resistors Rva1 and Rvb2, as shown. Transistor Qv1 is controlled (i.e., turned ON/closed or turned OFF/opened) responsive to enable signal EN1 of enable signals 112 for battery B1 as generated by controller 104. Enable signal EN1 drives a transistor drive circuit (including transistor Q1, resistors R1 and R2, and a capacitor C1) connected to a control terminal (e.g., a base) of the transistor Qv1. When transistor Qv1 is ON responsive to enable signal EN, the transistor connects terminal T1 to voltage divider VD (1). Then, the battery voltage VIB1 at terminal T1 is divided across resistors Rva1 and Rvb1, and the divided voltage appears as Va1 (signal_1), which is indicative/representative of the battery voltage at terminal T1, according to the equation:

$$Va 1 = battery voltage VIB 1 \cdot Rvb 1 / ( Rva 1 + Rvb 1 ) .$$

Voltage divider VD(1) provides sensed voltage Va1 (signal_1) to controller 104, which measures that voltage. Controller 104 can derive the battery voltage (i.e., the sense voltage at terminal T1) based on the above-equation. Conversely, when OFF, transistor Qv1 disconnects voltage divider VD(1) from terminal T1, which prevents current flow through the voltage divider, and reduces leakage current.

Remaining sense circuits sens2 and sens3 of the set of sense circuits 110(1) are configured similarly to sense circuit sens1. For example, sens2 includes a voltage divider VD(2) comprising resistors Rsa1, Rsb1, and sens3 includes a voltage divider VD(3) comprising resistors Rta1, Rtb1 configured similarly to resistors Rva1, Rvb2 of voltage divider VD(1). Therefore, the description of sense circuit sens1 shall suffice for the other sensor circuits.

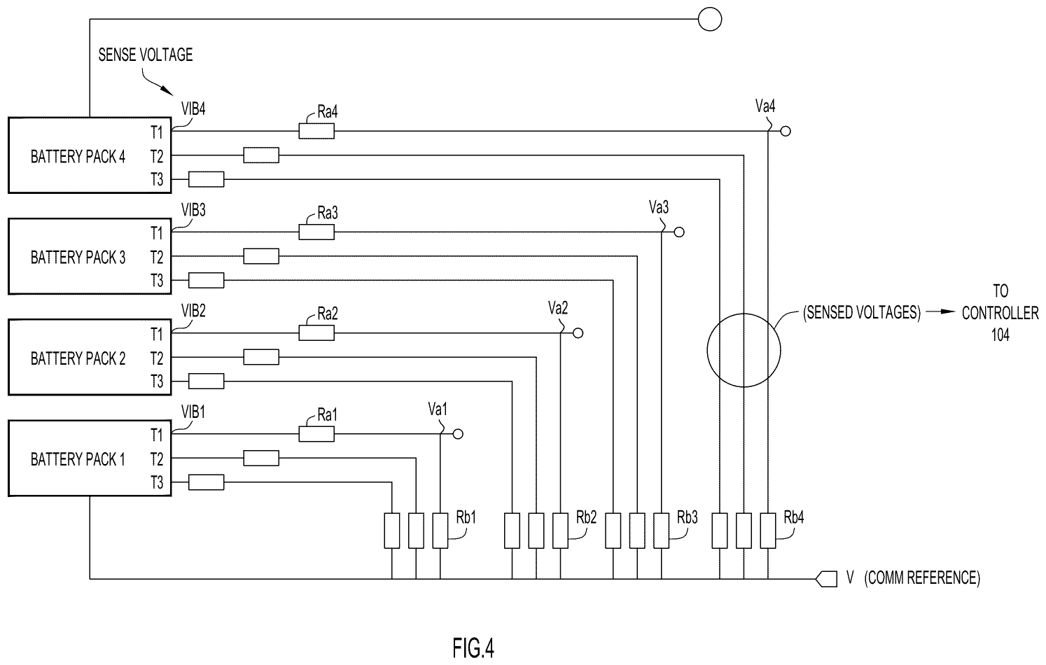

As mentioned above, controller 104 monitors the sets of sense voltages provide by respective ones of series connected batteries B1-B4. That is, controller 104 separately measures a battery voltage, a split stack voltage, and a battery temperature voltage on each of batteries B1-B4. One technique that may be used to measure the voltages is to isolate the batteries from each other at their terminals and measure the voltage sets in that isolated configuration; however, this approach can become complicated. Accordingly, a simplified technique presented herein to measure the sense voltages measures the sense voltages from all of the batteries with reference to a negative terminal potential (which serves as a common reference ground potential) of lowest battery B1. An advantage of this technique is that batteries B1-B4 need not be isolated from each other for purposes of monitoring their respective sense voltages. The technique stacks or builds measurements of the sets of sense voltages one on top of the other starting from bottom battery B1 up to battery B4. The measurements are then compensated to account for the stacking depending on which battery in the stack provided the measurements, to derive the actual per battery sense voltages relative to the individual negative terminal for the given battery, as described below in connection with FIG. 4.

FIG. 4 is an illustration of the above-mentioned technique of measuring the separate sets of sense voltages from batteries B1-B4 with reference to the common ground of lowest battery B1. This technique may be referred to below as the “common ground reference technique.” For convenience, only resistive dividers of the sense circuits Sens1, Sens2, and Sens3 are shown in FIG. 4. In FIG. 4, each pair or resistors Ra1, Rb1 (shown as boxes) together comprise a voltage divider VD (i), as described above in FIG. 3. For example:
a. Resistors Ra1, Rb1 (which correspond to resistors Rva1, Rvb1 in FIG. 4) comprise a voltage divider connected to battery voltage VIB1 (at sense terminal T1) of battery B1, to produce sensed battery voltage Va1 for battery B1, which is provided to controller 104.
b. Resistors Ra2, Rb2 comprise a voltage divider connected to battery voltage VIB2 (at sense terminal T1) of battery B2, to produce sensed battery voltage Va2 for battery B2, which is provided to the controller.
c. Resistors Ra3, Rb3 comprise a voltage divider connected to battery voltage VIB3 (at sense terminal T1) of battery B3, to produce sensed battery voltage Va3 for battery B3, which is provided to the controller.
d. Resistors Ra4, Rb4 comprise a voltage divider connected to battery voltage VIB4 (at sense terminal T1) of battery B4, to produce sensed battery voltage Va4 for battery B4, which is provided to the controller.

Battery sense terminals T2 and T3 of each battery Bi respectively provide sense voltages for the split stack voltage and the battery temperature voltage through corresponding resistive dividers similarly to battery sense terminal T1.

The techniques presented herein use the above-described sensed voltages to estimate a variety of individual battery health parameters for each battery Bi, including a battery type, a battery voltage, a battery temperature, a cell imbalance, and a battery SOC. The techniques further use the SOC to determine remaining arc ON time and a number of electrodes that can be used for welding, as will be described below.

### Individual Battery Type

The type of battery (i.e., “battery type”) is estimated for each battery Bi by computing a discharge rate of each battery Bi while in a loading condition. By computing the rate of fall of the (sensed) battery voltage during welding, for example, the battery type is estimated. The battery discharge rate may indicate that the battery type is 12 Ah, 9 Ah or 6 Ah, for example. The battery type for battery Bi is used to estimate the individual SOC for battery Bi.

### Individual Battery Voltages

Controller 104 employs the common ground reference technique to measure/compute individual battery voltages for each of batteries B1-B4 with respect to their own negative terminals in the following manner. Sensed voltages Va4, Va3, Va2, and Va1 presented by the respective voltage dividers described above represent voltages that successively build on each other beginning with the negative terminal voltage V− of bottom battery B1. That is, sensed voltage Va1 is referenced to the negative terminal voltage V−, then, Va2 builds on Va1, Va3 builds on Va2, and Va4 builds on Va3. Accordingly, after sensing stacked individual sensed battery voltages Va1, Va2, Va3, and Va4 with reference to the common ground (i.e., the negative terminal of battery B1), controller 104 computes their corresponding stacked individual battery voltages VIB1, VIB2, VIB3, and VIB4 with reference to the common ground using equations (1)-(4). Then, controller 104 uses those results to compute individual battery voltages Vcp1, Vcp2, Vcp3, and Vcp4 for batteries B1, B2, B3, and B4, respectively, with reference to their own negative terminals, according to equation (5). Essentially, equation (5) “de-stacks” the stacked voltages.

$${V}_{IB 1} = {V}_{a 1} * \frac{{R}_{a 1} + {R}_{b 1}}{{R}_{b 1}} \qquad ( 1 )$$

$${V}_{IB 2} = {V}_{a 2} * \frac{{R}_{a 2} + {R}_{b 2}}{{R}_{b 2}} \qquad ( 2 )$$

$${V}_{IB 3} = {V}_{a 3} * \frac{{R}_{a 3} + {R}_{b 3}}{{R}_{b 3}} \qquad ( 3 )$$

$${V}_{IB 4} = {V}_{a 4} * \frac{{R}_{a 4} + {R}_{b 4}}{{R}_{b 4}} \qquad ( 4 )$$

$$( 5 )$$

$${V}_{cp 1} = {V}_{IB 1} - 0 ; {V}_{cp 2} = {V}_{IB 2} - {V}_{cp 1} ; {V}_{cp 3} = {V}_{IB 3} - {V}_{cp 2} ; {V}_{cp 4} = {V}_{IB 4} - {V}_{cp 3}$$

### Individual Battery Temperature Measurement

Individual battery temperatures may be measured/computed in the following manner. Controller 104 estimates an individual battery internal negative temperature coefficient (NTC) resistance value for each of batteries B1-B4 using equations (6)-(9) listed below. Then, controller 104 determines an individual temperature for each battery based on a lookup of a temperature vs. resistance value graph provided by a manufacturer for of the battery, based on the resistance value.

$${R}_{NTC 1} = \frac{( ( {R}_{tb 1} * {R}_{8 \_ 1} ) * ( {V}_{a 1} * \frac{{R}_{a 1} + {R}_{b 1}}{{R}_{b 1}} - {V}_{t 1} * \frac{{R}_{ta 1} + {Rt}_{b 1}}{{R}_{tb 1}} ) )}{{V}_{t 1} * ( {R}_{ta 1} + {Rt}_{b 1} + {R}_{{8}_{1}} ) - ( 0.7 * {Rt}_{b 1} )} \qquad ( 6 )$$

$${R}_{NTC 2} = \frac{( ( {R}_{tb 2} * {R}_{8 \_ 2} ) * ( {V}_{a 2} * \frac{{R}_{a 2} + {R}_{b 2}}{{R}_{b 2}} - {V}_{t 2} * \frac{{R}_{ta 2} + {R}_{tb 2}}{{R}_{tb 2}} ) )}{{V}_{t 1} * ( {R}_{ta 2} + {R}_{tb 2} + {R}_{8 \_ 2} ) - ( 0.7 * {R}_{tb 2} )} \qquad ( 7 )$$

$${R}_{NTC 3} = \frac{( ( {R}_{tb 3} * {R}_{{8}_{3}} ) * ( {V}_{a 3} * \frac{{R}_{a 3} + {R}_{b 3}}{{R}_{b 3}} - {V}_{t 3} * \frac{{R}_{ta 3} + {R}_{tb 3}}{{R}_{tb 3}} ) )}{{V}_{t 1} * ( {R}_{ta 3} + {R}_{tb 3} + {R}_{8 \_ 3} ) - ( 0.7 * {R}_{tb 3} )} \qquad ( 8 )$$

$${R}_{NTC 4} = \frac{( ( {R}_{tb 4} * {R}_{8 \_ 4} ) * ( {V}_{a 4} * \frac{{R}_{a 4} + {R}_{b 4}}{{R}_{b 4}} - {V}_{t 4} * \frac{{R}_{ta 4} + {R}_{tb 4}}{{R}_{tb 4}} ) )}{{V}_{t 4} * ( {R}_{ta 4} + {R}_{tb 4} + {R}_{8 \_ 4} ) - ( 0.7 * {R}_{tb 4} )} \qquad ( 9 )$$

### Individual Cell Imbalance Monitoring

Controller 104 measures/computes an individual split stack voltage with reference to the common ground for each of batteries B1-B4 using equations (10)-(13) listed below. Controller 104 then computes individual split stack voltages Vsp1, Vsp2, Vsp3, and Vsp4 of batteries B1, B2, B3, and B4, respectively, with reference to their own negative terminals (e.g., ground terminals) using equation (14). In an example, the average current drawn from the split stack terminal may be approximately 100 uA.

$${V}_{Is 1} = {V}_{s 1} * \frac{{R}_{a 1} + {R}_{b 1}}{{R}_{b 1}} \qquad ( 10 )$$

$${V}_{Is 2} = {V}_{s 2} * \frac{{R}_{a 2} + {R}_{b 2}}{{R}_{b 2}} \qquad ( 11 )$$

$${V}_{Is 3} = {V}_{s 3} * \frac{{R}_{a 3} + {R}_{b 3}}{{R}_{b 3}} \qquad ( 12 )$$

$${V}_{Is 4} = {V}_{s 4} * \frac{{R}_{a 4} + {R}_{b 4}}{{R}_{b 4}} \qquad ( 13 )$$

$${V}_{sp 1} = {V}_{Is 1} - 0 ; {V}_{sp 2} = {V}_{Is 2} - {V}_{sp 1} ; {V}_{sp 3} = {V}_{Is 3} - {V}_{sp 2} ; {V}_{sp 4} = {V}_{Is 4} - {V}_{sp 3} ; \qquad ( 14 )$$

In the example in which each battery Bi comprises 5 series-connected cells, the split stack voltage is taken at the output from the third cell in the series. Controller 104 measures/computes, for each battery Bi, (i) a per-cell voltage from the 5-cell stacked voltage according to equation (15), and (ii) a 3-cell stack voltage according to equation (16).

$${V}_{cp 1} = \frac{{V}_{BP 1}}{5} \qquad ( 15 )$$

$${V}_{css 1} = \frac{{V}_{ss 1}}{3} \qquad ( 16 )$$

Controller 104 determines whether there is a cell imbalance based on V_{cp1} and V_{css1}. For example, controller 104 computes the cell imbalance based on an assumption that the cell imbalance occurs in one cell. The condition for balance/imbalance: if V_{cp1}-V_{css1} is greater than a predetermined voltage, then battery Bi is imbalanced.

### Individual Battery State of Charge (SOC)

Techniques presented herein determine an individual SOC (e.g., percentage of available charge/energy remaining) of each battery Bi. After the type of battery has been identified for battery Bi, the SOC of battery Bi is estimated using a method that combines integration-based SOC estimation with open circuit voltage (OCV)-based SOC estimation. To determine the individual SOC of individual battery Bi, the battery voltage of the battery Bi, the battery current, and the OCV of the battery Bi are measured. The SOC is computed using the method below. First, V_{Cocv} is computed using the following SOC equation:

$${V}_{Cocv} = ( {V}_{abv} + {I}_{abc} \times \frac{{V}_{FC} - {V}_{mOCV}}{{I}_{abc}^{*}} ) ,$$

where, V_{abv} is measured battery voltage during loading condition, I_{abc} is the battery current, V_{FC} is the fully charged voltage, V_{mOCV} is the measured OCV voltage, and V_{Cocv} is the calculated OCV voltage during loading condition.

The SOC of battery Bi is then estimated from a lookup table. For example, based on the V_{Cocv}, the SOC of battery Bi is estimated from the discharge capacity of the cell.

### Battery Utilization Based on SOC—Arc On Time

Batteries B provide battery power to create and maintain an arc for a welding operation, which drains the batteries B over time based on the amount of battery power necessary to support the welding operation. At any given time, the individual SOCs for batteries B1-B4 (referred to as the “SOC information”) indicate the energy remaining in the individual batteries. Therefore, the SOC information translates to a length of time batteries B can support the welding operation, such as a remaining time that the batteries can maintain the arc. Accordingly, techniques presented herein estimate a remaining arc ON time based on the SOC information and a type of welding process that is selected, such as MMA, TIG, or GMAW, for example. For MMA welding, the techniques further estimate a number of electrodes to weld (i.e., how many more electrodes can be welded based on the current battery SOC). Such information is useful to a weld operator. Accordingly, the techniques present estimates of arc ON time, number of electrodes, and so on, to the weld operator through HMI 103.

Controller 104 performs the following operations to determine the remaining arc ON time and number of electrodes to weld. First, controller 104 determines the individual SOC for each battery Bi, and selects a lowest individual SOC among all of the SOCs. Because batteries B1-B4 are connected in series, the individual battery that has the lowest SOC likely will be fully discharged first and therefore be the limiting factor that dictates the remaining arc ON time, assuming the batteries are of a similar type. Second, controller 104 receives weld parameters for a selected welding process. The weld parameters may be entered into HMI 103 by the operator and/or measured/determined by the welding system. Such weld parameters include, but are not limited to, a weld current setting, a weld voltage setting, a type of electrode, electrode dimensions, the type of weld process selected, a weld current (actual/measured), and a weld voltage (actual/measured). Third, based on the weld parameters and the SOC information (e.g., the lowest individual SOC), controller 104 determines the remaining arc ON time and the number of electrodes to weld (when MMA welding is selected). Fourth, controller 104 provides the remaining arc ON time and the number of electrodes to weld to HMI 103, which presents that information to the operator.

The “Arc ON Time” may be estimated using the following formula:

$$Arc ON Time = ( available battery energy * efficiency of battery power DC \text{} - DC converter ) / Required Arc ON Power \qquad ( 17 )$$

Where, the the “Required Arc ON Power” is calculated as:

$$Arc ON power = weld output voltage * weld output current \qquad ( 18 )$$

The “Available Battery Energy” is calculated based on the following:

$$Available Battery Energy = the Rated Energy of the battery ( WH ) \times SOC of the battery ( \% ) \qquad ( 19 )$$

The number of MMA (stick) electrodes that can be welded is calculated by knowing the energy required to weld one electrode (which may be predetermined/premeasured) and the available battery energy. E.g., for welding one 2.5 mm diameter and 250 mm length electrode, 44 WH energy is required. So, with an 864 WH battery Bi, 16 electrodes can be welded based on 100% SOC. If the SOC is 50%, then the possible number of electrodes that can be used with the remaining battery charge is 8.

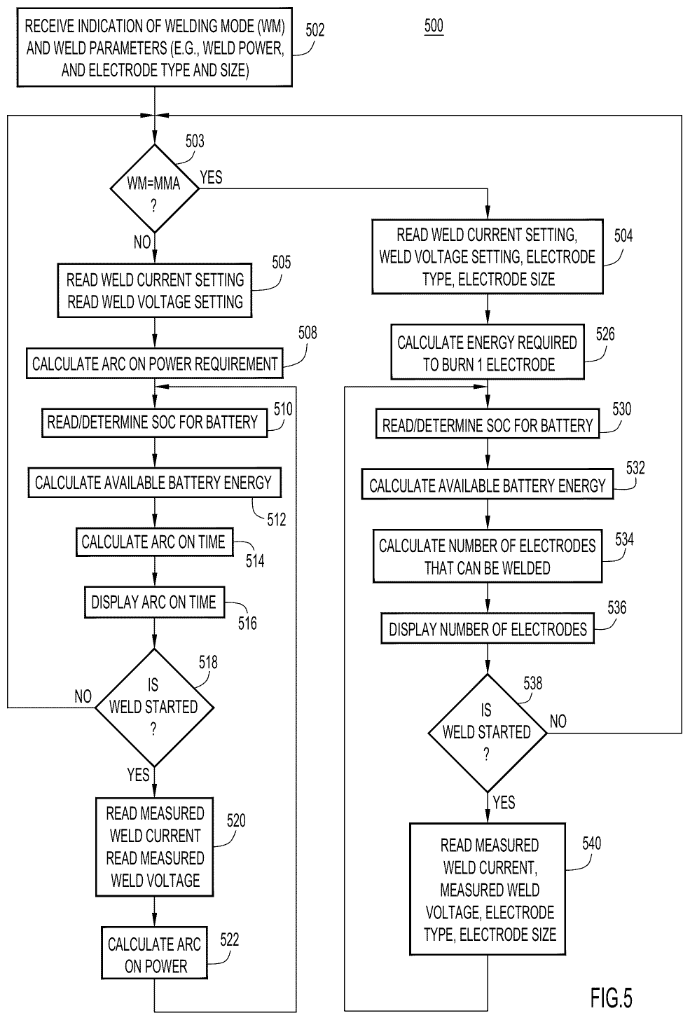

FIG. 5 is a flowchart of an example method 500 of determining a remaining amount of welding or plasma cutting activity for a welding mode or process that is supported by the battery. For example, method 500 performs (i) determining a remaining arc ON time for different types of welding processes, and (ii) determining a number of stick electrodes for an MMA welding process.

At 502, controller 104 receives and stores information identifying/selecting a welding mode (also referred to as a type of welding process or weld process type) to be performed, i.e., a welding mode in which the welding system is to operate. Controller 104 also receives and stores weld parameters associated with/for the welding mode. In an example, controller 104 receives information identifying the welding mode and the weld parameters from/through HMI 103. For example, an operator enters the information through/using HMI 103. The welding mode (i.e., the “selected welding mode”) may be selected from any of metal inert gas (MIG)/metal active gas (MAG) (MIG/MAG) welding, tungsten inert gas (TIG) welding, flux cored arc welding (FCAW), manual metal arc (MMA) welding (e.g., shielded metal arc welding (SMAW) or stick welding), and submerged arc welding (SAW), for example. The welding mode may also include plasma cutting. The weld parameters may include, but are not limited to, a weld power setting for HP power source 100. The weld power setting may include a weld current setting and a weld voltage setting. For MMA welding, the weld parameters may further include a type of stick electrode to be welded and a size (e.g., dimensions including a diameter and a length) of the stick electrode. The type may be indicative of the size.

At 503, controller 104 determines whether the welding mode is MMA or not MMA. When the welding mode is MMA, flow proceeds to 504-540. When the welding mode is not MMA, flow proceeds to 505-520.

At 505, controller 104 receives the weld power setting including the weld voltage setting and the weld current setting. Controller 104 may read the weld power setting from HMI 103 upon entry of the weld power setting by the operator, or may read/access the weld power setting from memory when the weld power setting is stored in memory.

At 508, controller 104 determine/computes the Required Arc ON Power (i.e., Arc ON Power requirement) as:
Required Arc ON power=weld voltage setting*weld current setting.

At 510, controller 104 determines/computes the SOC of battery B as described above.

At 512, controller 104 determines/computes the Available Battery Energy as:
Available Battery Energy=WH (i.e., battery capacity)*SOC*battery efficiency (use of battery efficiency is optional).

At 514, controller 104 determines/computes the Arc ON Time as:
Arc ON Time=Available Battery Energy/Required Arc ON Power.

At 516, controller 104 indicates the Arc ON Time to the operator through HMI 103. For example, controller 104 causes HMI 103 to display the Arc ON Time.

At 518, controller 104 determines whether welding has started. When welding has not started, flow returns to 503. When welding has started, flow proceeds to 520.

At 520, controller 104 receives a measurement of weld power (e.g., measured weld current and measured weld voltage), and then flow proceeds to 522. At 522, controller 104 determines/computes the ARC ON Time using the measured weld current and voltage, and flow returns to 510, so the cycle repeats.

At 504, controller 104 receives the weld power setting, and indication of the type of stick electrode, and an indication of the size of the stick electrode. Controller 104 may read the aforementioned parameters from HMI 103 upon their entry by the operator, or may read/access the aforementioned parameters from memory when they are stored in memory.

At 526, controller 104 determines/computes an energy required to burn/weld one stick electrode completely (referred to as “Energy for 1 Electrode”). Controller 104 may determine the energy required to burn/weld one stick electrode based on one or more of the type of the stick electrode and the size of the stick electrode. In one example, any known or hereafter developed technique to compute the energy may be used, e.g., Energy for 1 Electrode=weld power*time to burn the stick electrode completely. Alternatively, the Energy for 1 Electrode of a given size may be predetermined and stored in a database (i.e., a predetermined database) so as to be indexed, and thus retrievable, by controller 104 based on one or more of the type and size. For example, the database may store a list of known stick electrode sizes (e.g., diameter and/or length) for stick electrodes mapped to corresponding ones of values of Energy for 1 Electrode. That is, the database maps the known stick electrode sizes to corresponding values of Energy for 1 Electrode. Armed with a given stick electrode size, controller 104 may use the stick electrode size as an index to retrieve from the database a corresponding Energy for 1 electrode that is mapped to the given stick electrode size. Alternatively, the database may store a list of known stick electrode types (which are indicative of their sizes) mapped to corresponding ones of values of Energy for 1 Electrode. Armed with a given stick electrode type, controller 104 may use the given stick electrode type as an index to retrieve from the database a corresponding Energy for 1 electrode that is mapped to the given stick electrode type.

At 530, controller 104 determines the SOC of battery B.

At 532, controller 104 computes the Available Battery Energy.

At 534, controller 104 computes the number (No.) of stick electrodes that can be welded as:
No. of stick electrodes=Available Battery Energy/Energy for 1 Electrode.

At 536, controller 104 indicates the No. of stick electrodes. For example, controller 104 causes HMI 103 to display the No. of stick electrodes.

At 538, controller 104 determines whether welding has started. When welding has not started, flow returns to 503. When welding has started, flow proceeds to 540.

At 540, controller 104 reads/receives the measured weld power, and flow returns to 530, so the cycle repeats.

Another arrangement of method 500 additionally incorporates operations 512-522 into the MMA leg of method 500, i.e., to determine and present the Arc ON Time for the MMA welding in addition to the number of stick electrodes.

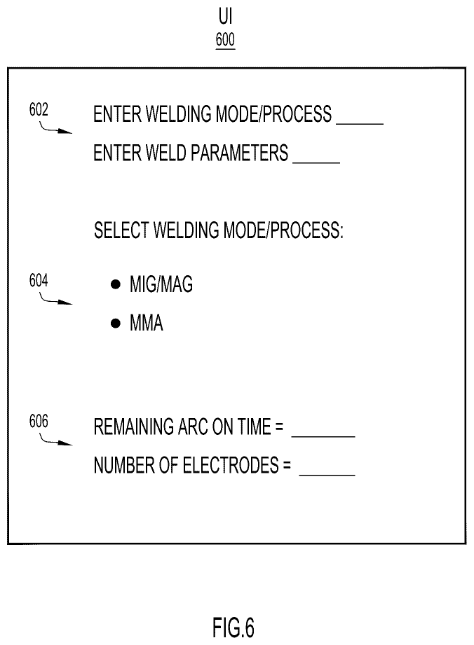

FIG. 6 is an illustration of an example user interface (UI) 600 that controller 104 may generate for display, and HMI 103 may display in connection with the methods presented herein. UI 600 includes user prompts 602 that prompt the operator to enter the welding mode/process to be used and weld parameters associated with the welding. Upon entry of the information responsive to prompts 602, controller 104 receives the information. Alternatively, or additionally, UI 600 may present user selection options 604 for the welding mode that the operator may select. Upon selection of one of the user selection options 604, controller 104 receives the selected option, i.e., the selected welding mode. UI 600 also presents computed information 606, including the remaining ARC ON Time and the number of electrodes.

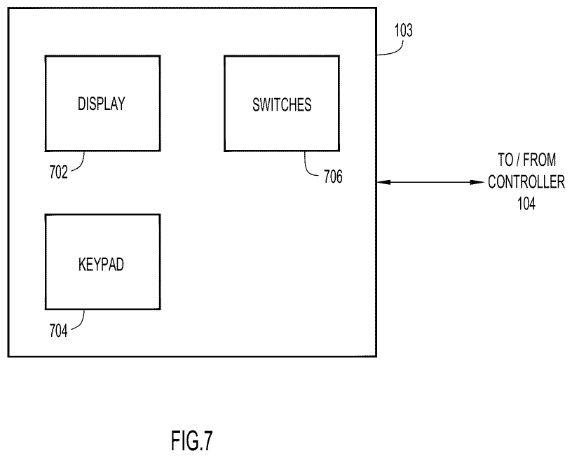

FIG. 7 is an illustration of HMI 103 according to an embodiment. In the example, HMI 103 includes a display 702 to present information, an alphanumeric keypad 704 through which the operator may enter information, and switches or press buttons 706 (e.g., an ON/OFF user switch and the like) through which the operator may interact with welding system WS. In another embodiment, HMI 103 may be incorporated as part of a computer device, such as a personal computer (laptop, desktop), tablet computer, SmartPhone, and the like, with user input and output devices, such as a display, keyboard, mouse, and the like.

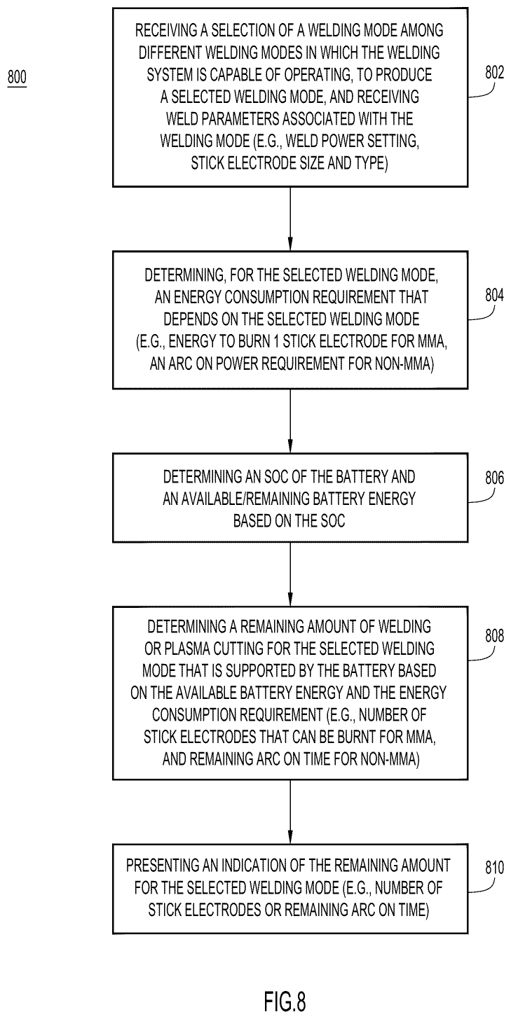

FIG. 8 is a flowchart of another example method 800 of determining a remaining amount of welding or plasma cutting activity that is supported by the battery for a selected welding mode. Method 800 may be performed by a welding system (e.g., welding system WS) having a battery-powered (welding) power source (e.g., HP power source 100) configured to be powered by a battery (e.g., battery B) to generate weld power to strike an arc for a welding or a plasma cutting operation.

802 includes receiving a selection (e.g., through HMI 103) of a welding mode among different welding modes in which the welding system is capable of operating, to produce a selected welding mode. The possible welding modes may include (i) MMA welding that burns/welds consumable stick electrodes, and (ii) one or more non-MMA welding modes that include MIG/MAG welding, TIG welding, FCAW, submerged arc welding (SAW), and plasma cutting.

804 includes determining, for the selected welding mode, an energy consumption requirement that depends on the selected welding mode. The term “energy” consumption requirement is construed to cover both “energy” and “power” consumption requirements. The energy consumption requirement may differ across the welding modes. For example, the energy consumption requirement may include (i) an arc ON power requirement (e.g., the power to turn ON and maintain an ARC), and/or (ii) an energy to burn/weld 1 stick electrode of a given type or size in MMA.

806 includes determining an SOC of the battery and an available/remaining battery energy from the SOC.

808 includes determining a remaining amount of welding or plasma cutting for the selected welding mode that is supported by the battery based on the battery energy and the energy consumption requirement.

810 includes presenting (e.g., displaying on HMI 103) an indication of the remaining amount for the selected welding mode.

Method 800 further includes, while generating the weld power and operating in the selected welding mode to perform the welding or the plasma cutting operation, repeating 804-810 using measured weld power to compute various variables in place of using weld power settings to compute the various variables.

Method 800 further includes, upon determining that the selected welding mode is MMA welding that burns/welds stick electrodes:
a. Accessing one or more of a type and a size of each stick electrode.
b. Determining, as the energy consumption requirement, an energy unit required to weld each stick electrode (e.g., an energy required to burn one stick electrode completely) based on the type and/or size.
c. Computing, as the remaining amount, a number of the stick electrodes that can be welded with the battery energy based on the energy unit.
d. Presenting the number (e.g., displaying the number on HMI 103).

In another example, method 800 includes receiving a weld power setting for the selected welding mode and, upon determining that the selected welding mode is not MMA welding, performing:
a. Computing, as the energy consumption requirement, an arc ON power requirement based on the weld power setting.
b. Computing, as the remaining amount, an arc ON time based on the battery energy and the arc ON power requirement.
c. Presenting includes presenting the arc ON time (e.g., displaying the same on HMI 103).

Once welding begins in the non-MMA welding, method 800 includes receiving measured weld power from the HP power source and repeating (a)-(c) above using the measured weld power instead of the weld power setting.

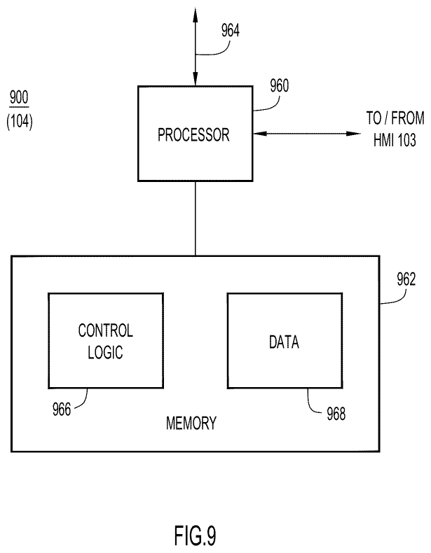

FIG. 9 is a block diagram of a controller 900 according to an embodiment. Controller 900 may be implemented in one or more of the components described herein. For example, controller 900 may represent controller 104 implemented in battery box 102 and/or a controller of HP power source 100 that is incorporated in the HP power source and that performs the functions of controller 104. Controller 900 includes processor(s) 960 and a memory 962 coupled to one another. The aforementioned components may be implemented in hardware, software, or a combination thereof. Processor(s) 960 communicate with external components/modules/circuits, such as sense circuits 110, battery B, and HP power source 100 (e.g., to receive weld power measurements) over interfaces 964. Processor(s) 960 also communicate with HMI 103. Memory 962 stores control software 966 (referred as “control logic”), that when executed by the processor(s) 960, causes the processor(s), and more generally, controller 900, to perform the various operations described herein. Control software 966 also includes logic to implement/generate for display graphical user interfaces (GUIs) or, more generally, UIs, in connection with HMI 103 as necessary in connection with the above-described methods/operations.

The processor(s) 960 may be a microprocessor or microcontroller (or multiple instances of such components). The memory 962 may include read only memory (ROM), random access memory (RAM), magnetic disk storage media devices, optical storage media devices, flash memory devices, electrical, optical, or other physically tangible (i.e., non-transitory) memory storage devices. Controller 900 may also be discrete logic embedded within an integrated circuit (IC) device.

Memory 962 also stores data 968 used and generated by control software 966.

The above description is intended by way of example only. Although the techniques are illustrated and described herein as embodied in one or more specific examples, it is nevertheless not intended to be limited to the details shown, since various modifications and structural changes may be made within the scope and range of equivalents of the claims.

What is claimed is:

1. A method performed by a welding system configured to be powered by a battery to generate weld power to strike an arc for a welding or a plasma cutting operation, comprising:
receiving a selection of a welding mode among different welding modes in which the welding system is capable of operating, to produce a selected welding mode;
determining, for the selected welding mode, an energy consumption requirement that depends on the selected welding mode;
determining a state of charge (SOC) of the battery and a battery energy from the SOC;
determining a remaining amount of welding or plasma cutting that is supported by the battery energy based on the battery energy and the energy consumption requirement; and
presenting an indication of the remaining amount for the selected welding mode.

2. The method of claim 1, further comprising:
generating the weld power and operating in the selected welding mode to perform the welding or the plasma cutting operation; and
repeating determining the energy consumption requirement, determining the SOC and the battery energy, determining the remaining amount, and presenting.

3. The method of claim 1, further comprising, upon determining that the selected welding mode is manual metal arc (MMA) welding that welds stick electrodes:
accessing one or more of a size and a type of each stick electrode;
determining, as the energy consumption requirement, an energy unit required to weld each stick electrode based on one or more of the size and the type;
computing, as the remaining amount, a number of the stick electrodes that can be welded with the battery energy based on the energy unit; and
presenting the number.

4. The method of claim 1, further comprising:
receiving a weld power setting for the selected welding mode; and
upon determining that the selected welding mode is not manual metal arc (MMA) welding:
computing, as the energy consumption requirement, an arc ON power requirement based on the weld power setting;
computing, as the remaining amount, an arc ON time based on the battery energy and the arc ON power requirement; and
presenting includes presenting the arc ON time.

5. The method of claim 4, wherein:
receiving the weld power setting includes receiving a weld current setting and a weld voltage setting; and
computing the arc ON power requirement based on the weld current setting and the weld voltage setting.

6. The method of claim 1, wherein:
receiving the selection includes receiving the selection through a human machine interface (HMI) of the welding system; and
presenting includes displaying the indication of the remaining amount on the HMI.

7. The method of claim 1, wherein the different welding modes include manual metal arc (MMA) welding that uses consumable stick electrodes and one or more of metal inert gas (MIG)/metal active gas (MAG) (MIG/MAG) welding, tungsten inert gas (TIG) welding, flux cored arc welding (FCAW), submerged arc welding (SAW), and plasma cutting.

8. The method of claim 1, wherein:
determining the battery energy includes determining the battery energy based on the SOC, a known battery capacity, and a known battery efficiency.

9. A welding system including a power source to be powered by a battery to generate weld power to strike an arc for a welding or a plasma cutting operation, comprising:
a human machine interface (HMI); and
a controller coupled to the power source and the HMI and configured to perform:
receiving, from the HMI, a selection of a welding mode among different welding modes in which the welding system is capable of operating, to produce a selected welding mode;
determining, for the selected welding mode, an energy consumption requirement that depends on the selected welding mode;
determining a state of charge (SOC) of the battery and a battery energy from the SOC;
determining a remaining amount of welding or plasma cutting that is supported by the battery energy based on the battery energy and the energy consumption requirement; and
presenting, on the HMI, an indication of the remaining amount for the selected welding mode.

10. The welding system of claim 9, wherein the controller is further configured to perform:
while the power source generates the weld power and operates in the selected welding mode for the welding or the plasma cutting operation, repeating determining the energy consumption requirement, determining the SOC and the battery energy, determining the remaining amount, and presenting.

11. The welding system of claim 9, wherein the controller is further configured to perform, upon determining that the selected welding mode is manual metal arc (MMA) welding that welds stick electrodes:
accessing one or more of a size and a type of each stick electrode;
determining, as the energy consumption requirement, an energy unit required to weld each stick electrode based on one or more of the size and the type;
computing, as the remaining amount, a number of the stick electrodes that can be welded with the battery energy based on the energy unit; and
presenting the number.

12. The welding system of claim 9, wherein the controller is further configured to perform:
receiving a weld power setting for the selected welding mode; and
upon determining that the selected welding mode is not manual metal arc (MMA) welding:
computing, as the energy consumption requirement, an arc ON power requirement based on the weld power setting;
computing, as the remaining amount, an arc ON time based on the battery energy and the arc ON power requirement; and
presenting includes presenting the arc ON time.

13. The welding system of claim 12, wherein the controller is configured to perform:
receiving the weld power setting by receiving a weld current setting and a weld voltage setting; and
computing the arc ON power requirement by computing the arc ON power requirement based on the weld current setting and the weld voltage setting.

14. The welding system of claim 9, wherein the different welding modes include manual metal arc (MMA) welding that uses consumable stick electrodes and one or more of metal inert gas (MIG)/metal active gas (MAG) (MIG/MAG) welding, tungsten inert gas (TIG) welding, flux cored arc welding (FCAW), submerged arc welding (SAW), and plasma cutting.

15. The welding system of claim 9, wherein the controller is configured to perform:
determining the battery energy by determining the battery energy based on the SOC, a known battery capacity, and a known battery efficiency.

16. A method performed by a welding system configured to be powered by a battery to generate weld power for an arc for manual metal arc (MMA) welding (MMA), comprising:
determining an energy required to weld a stick electrode;
determining a state of charge (SOC) of the battery and an available battery energy from the SOC;
computing a number of stick electrodes that can be welded with the battery based on the energy required to weld the stick electrode and the available battery energy; and
presenting the number of stick electrodes.

17. The method of claim 16, further comprising:
while generating the weld power and performing an MMA welding operation, repeating determining the SOC and the available battery energy, determining the number of stick electrodes, and presenting.

18. The method of claim 16, further comprising:
receiving one or more of a size and a type of the stick electrode,
wherein determining the energy to weld the stick electrode includes determining the energy to weld the stick electrode based on one or more of the size and the type.

19. The method of claim 18, wherein:
determining the energy to weld the stick electrode includes retrieving the energy to weld the stick electrode from a predetermined database that maps energies to weld stick electrodes to corresponding ones of one or more of sizes and types of the stick electrodes.

20. The method of claim 18, wherein:
receiving one or more of the size and the type of the stick electrode includes receiving one or more of the size and the type of the stick electrode through a human machine interface (HMI).
